(19) United States
(12) Patent Application Publication
(10) Pub. No.: US 2012/0223252 A1
(43) Pub. Date: Sep. 6, 2012

(54) SYSTEM, METHOD AND APPARATUS FOR AN IMAGING ARRAY USING NON-UNIFORM SEPTA

(75) Inventor: Peter R. Menge, Novelty, OH (US)

(73) Assignee: SAINT-GOBAIN CERAMICS & PLASTICS, INC., Worcester, MA (US)

(21) Appl. No.: 13/410,830

(22) Filed: Mar. 2, 2012

Related U.S. Application Data
(60) Provisional application No. 61/448,801, filed on Mar. 3, 2011.

(51) Int. Cl. G01T 1/20

(52) U.S. Cl. 250/486.1

(57) ABSTRACT

An imaging array has imaging pixels, non-uniform septa, an axial center and a radial perimeter. The septa are positioned in the array such that there is a septum between adjacent ones of the imaging pixels. At least one parameter of the septa varies at least once from the center to the perimeter of the array. The parameter may increase from the center to the perimeter. The parameter may comprise density or atomic number of the septa. Alternatively, the parameter of the septa may be their radial thicknesses which vary relative to the center.

### BACKGROUND OF THE INVENTION

1. Field of the Disclosure

The present invention relates in general to imaging arrays and, in particular, to a system, method and apparatus for a scintillator array for high energy imaging using non-uniform septa.

2. Description of the Related Art

Scintillation detectors are generally used to detect high energy emissions such as high energy photons, electrons or alpha particles that are not easily detected by conventional photodetectors. A scintillator, or scintillation crystal, absorbs high energy emissions and converts the energy to a light pulse. The light may be converted to electrons (i.e., an electron current) with a photodetector such as a photodiode, charge coupled detector (CCD) or photomultiplier tube. Scintillation detectors may be used in various industries and applications including medical (e.g., to produce images of internal organs), geophysical (e.g., to measure radioactivity of the earth), inspection (e.g., non-destructive, non-invasive testing), research (e.g., to measure the energy of photons and particles), and health physics (e.g., to monitor radiation in the environment as it affects humans).

Scintillation detectors typically include either a single large crystal or a large number of small crystals arranged in an array. Many scanning instruments include scintillation detectors that comprise pixelated arrays of scintillation crystals. Arrays can consist of many scintillation pixels that can be arranged in rows and columns. Pixels may be positioned parallel to each other and may be retained in position with an adhesive such as an epoxy. The array may be positioned in an imaging device so that one end of the array (high energy end) receives excitatory energy and the opposed end (light emitting end) transmits resultant visible light to a photodetector. Light exiting the emitting exit end can be correlated to a specific scintillation event in a specific pixel, and this light can be used to construct a pattern of excitatory energy impacting the high energy end of the array.

The pixels in scintillator arrays are physically separated from each other by dividers or septa. For example, the pixels and septa are generally aligned with and parallel to a central x-ray axis. The geometry of these devices often results in x-rays striking the array with more oblique angles at the edges than in the center. The angled trajectories of the x-rays lead to more energy sharing between the pixels due to Compton scattering relative to the axial direction of the original x-ray.

There have been some attempts to reduce energy sharing between pixels. For example, U.S. Pat. App. Pub. 2007/0086565, discloses pixels that are angled or focused toward the source of radiant energy. Although this solution is workable it can be cumbersome to manufacture and implement. Improvements in imaging array design and implementation continue to be of interest.

### SUMMARY

Embodiments of a system, method and apparatus for an imaging array using non-uniform septa are disclosed. In some embodiments, an imaging array comprises a plurality of imaging pixels that form an array. The array has a high energy end, a light exit end, an axial center and a radial perimeter. The septa are positioned in the array such that there is a septum between adjacent ones of the imaging pixels.

At least one parameter of the septa varies at least once from the septa adjacent the axial center of the array to the septa adjacent the radial perimeter of the array. For example, the at least one parameter of the septa may increase from the axial center to the radial perimeter. The parameter of the septa may comprise density or atomic number of the septa. The septa may comprise a plurality of strata of different materials.

Alternatively, the septa may have a radial thickness that varies relative to (e.g., increases away from) the axial center, such that the at least one parameter of the septa may be the radial thicknesses of the septa.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a schematic isometric view of an embodiment of a scintillation array;

FIG. 2 is a sectional top view of an embodiment of an array;

FIG. 3 is front view of another embodiment of a scintillation array;

FIG. 4 is a sectional top view of the array of FIG. 3;

FIG. 5 is front view of still another embodiment of a scintillation array; and

FIG. 6 is a sectional top view of the array of FIG. 5.

The use of the same reference symbols in different drawings indicates similar or identical items.

### DETAILED DESCRIPTION

Scintillation detectors are generally used to detect relatively high energy photons, electrons or alpha particles wherein high energy is 1 KeV or higher, including gamma rays, alpha particles and beta particles. It may be appreciated that these photons, electrons or alpha particles may not be easily detected by conventional photodetectors, which may, for example, be sensitive to photons at wavelengths of 200 nm or greater, including 200 nm to 800 nm. A scintillator, or scintillation crystal, ceramic or plastic, absorbs excitatory waves or particles and converts the energy of the waves or particles to a light pulse. The light may be converted to electrons (i.e., an electron current) with a photodetector such as a photodiode, charge-coupled detector (CCD) or photomultiplier tube.

As used herein, the term “high energy surface” or “high energy end” denotes the surface of a scintillation array or pixel through which high energy photons, electrons or alpha particles first enter. “Detectable light” is the light output by a scintillator that can be detected by a photodetector. Detectable light has a wavelength in the range of 200 to 700 nm. A “photodetector” converts detectable light emitted from a scintillation crystal into an electrical signal. The term “optically coupled” refers to at least one coupled element being adapted to impart light to another coupled element directly or indirectly. The term “scintillator” refers to a material that emits light (“scintillation light”) in response to high energy photons, electrons or alpha particles wherein high energy is 1 KeV or higher (“excitatory energy”). This excitatory energy includes gamma rays, alpha particles and beta particles incident thereon. Known scintillators include materials such as ceramic, crystal and polymer scintillators. A “scintillation crystal” is a scintillator made primarily of inorganic crystal. “Scintillation pixels” are known to those of skill in the art and comprise individual scintillators that are each associated with one or more photodetectors. Multiple scintillation pixels can be associated together to form a “scintillation array.” The array may be associated with one or more photodetectors. The detectable light from each pixel can be independently detected. The pixels may be separated from each other and may be joined via a common substrate. An “adhesive” as used herein is a material that can be used to join independent pixels together in an array or to preserve the spacing between pixels. A “diffuse” reflective material reflects a given ray of visible light in multiple directions. A “specular” reflective material reflects a given ray of visible light in a single direction. A material is “transparent” to visible light if it allows the passage of more than 50% of the visible light that impacts the material. A material is “opaque” if it blocks 80% or more of the visible light that impacts the material.

Scintillation detectors may be used in various industries and applications including medical (e.g., to produce images of internal organs), geophysical (e.g., to measure radioactivity of the earth), inspection (e.g., non-destructive, non-invasive testing), research (e.g., to measure the energy of photons and particles), and health physics (e.g., to monitor waves or particles in the environment as it affects humans). Medical devices may include positron emission tomography scanners, gamma cameras, computed tomography scanners and radioimmunoas say applications. Geophysical devices may include well logging detectors. Inspection devices may include radiance detectors, such as thermal neutron activation analysis detectors, luggage scanners, thickness gauges, liquid level gauges, security and manifest verification, both active and passive devices, spectroscopy devices (radioisotope identification devices), both active and passive devices, and gross counters, both active and passive. Research devices may include spectrometers and calorimeters. Health physics applications may include laundry monitoring and area monitoring.

Scintillation arrays often are composed of a group of scintillating pixels arranged in rows and columns to produce the array. Scintillation pixels may be inorganic or organic. Examples of inorganic scintillation pixels may include crystals such as thallium doped sodium iodide (NaI(Tl)) and thallium doped cesium iodide (CsI(Tl)). Additional examples of scintillation crystals may include barium fluoride, cerium-doped lanthanum chloride (LaCl₃(Ce)), bismuth germinate (Bi₄Ge₃O₁₂), cerium-doped yttrium aluminum garnet (Ce:YAG), cerium-doped lanthanum bromide (LaBr₃(Ce)), lutetium iodide (LuI₃), calcium tungstate (CaWO₄), cadmium tungstate (CdWO₄), lead tungstate (PbWO₄), zinc tungstate (ZnWO₄) and lutetium oxyorthosilicate (Lu₂SiO₅), as well as cerium doped-lutetium yttrium oxyorthosilicate (Lu_{1.8}Y_{0.2}SiO₅(Ce)) (LYSO). Scintillators may also include inorganic ceramics such as terbium-doped gadolinium oxysulfide (GOS(Tb)), and europium doped lutetium oxide (Lu₂O₃(Eu)). In addition, examples of organic scintillators may include polyvinyltoluene (PVT) with organic fluors present in the PVT as well as other polymer materials.

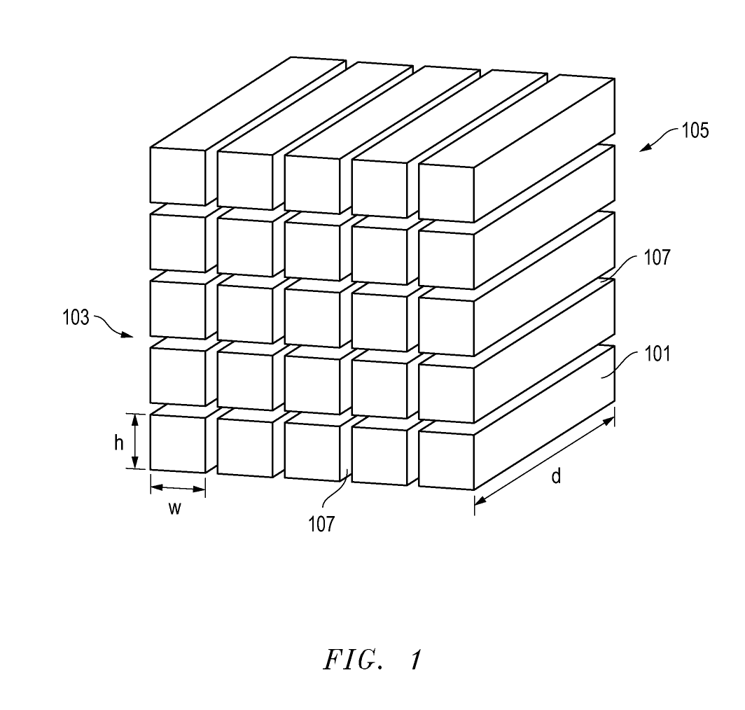

Arrays may include any number of scintillation pixels and pixels may be made of, for example, crystalline or polymeric material. As shown in FIG. 1, the depth (d) of pixel 101 may be greater than the width (w) and/or height (h) of pixel 101. The array can be placed in association with an imaging device so that high energy end 103 of the array is oriented toward the excitatory energy source. Light exiting end 105 can be associated with a photodetector so that light resulting from scintillation events can be detected. Each individual pixel may have one or a plurality of photodetectors associated with it. Space 107 between pixels may be occupied by a reflective, opaque material designed to channel light to light exiting end 105 of the array while minimizing crosstalk between pixels. In this manner, light generated within a specific pixel can be detected by a photodetector associated with that same pixel or by a portion of a photodetector associated with that pixel.

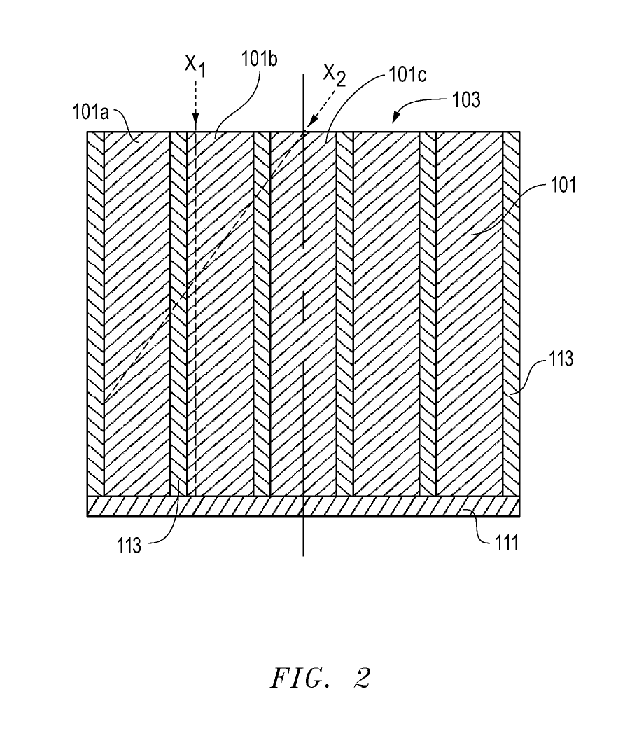

FIG. 2 provides a sectional view of a scintillation array showing the positioning of five aligned pixels. In this example, each pixel measures 4×4×30 mm. As shown, high energy end 103 is at the top of the figure and light exit window 111 is at the bottom, although visible light may also exit from the high energy end. Pixels 101, 101a, 101b and 101c include reflective barrier 113 separating the adjacent pixels. If excitatory energy enters the scintillation array along a path that is parallel to the depth of the pixels (direction X₁) the resulting scintillation event will take place in pixel 101b, regardless of how deep within the pixel the event occurs. However, if the excitatory energy enters the array at an angle (direction X₂), the resulting scintillation event may occur in any of pixels 101c, 101b or 101a, depending on how far the excitatory energy penetrates the array before scintillating. If the resulting scintillation event occurs in either pixel 101b or 101a, the resulting light will be detected as having occurred in 101b or 101a, rather than in pixel 101c, the first pixel penetrated by the excitatory energy. These parallax effects can cause distortion in the reconstructed image.

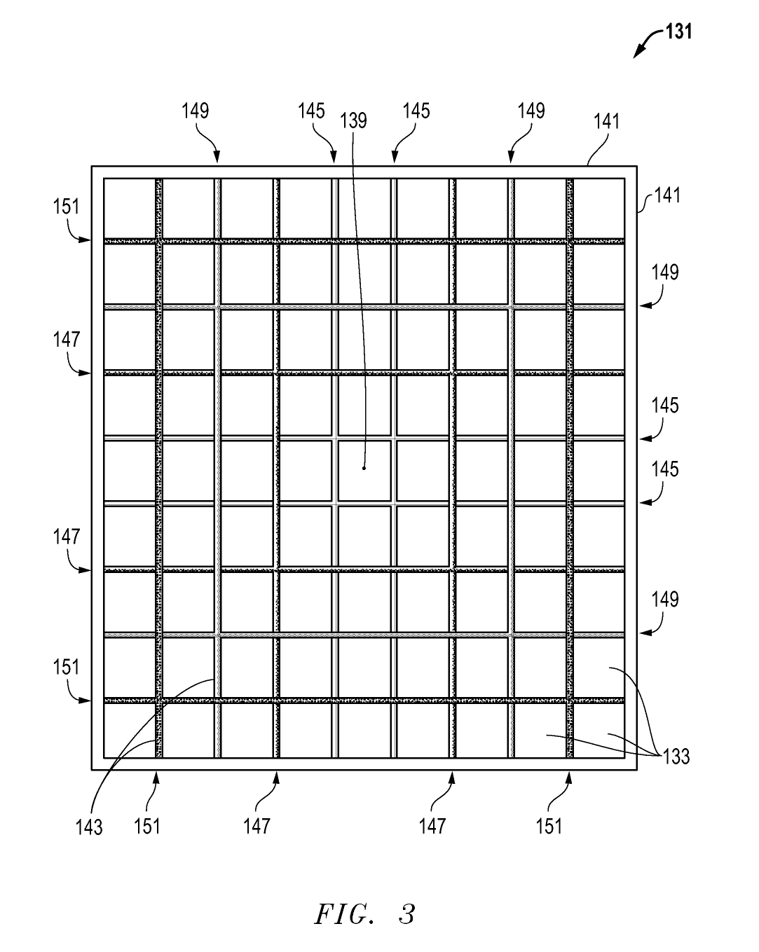

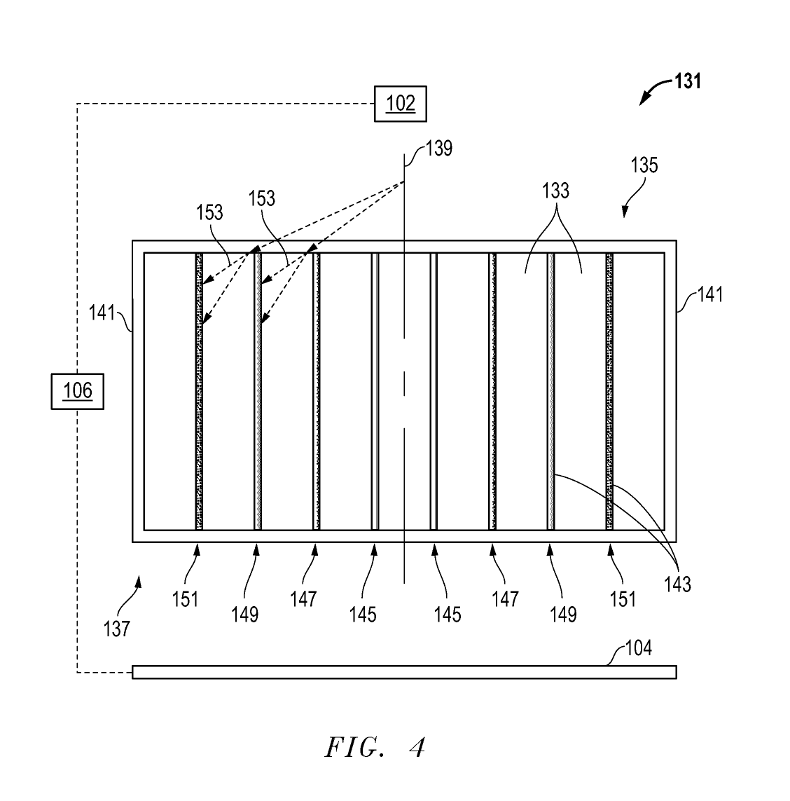

FIGS. 3 and 4 depict an embodiment of an imaging array 131, such as a scintillator pixel array. Imaging array 131 comprises a plurality of imaging pixels 133 (e.g., scintillation pixels) that form an array, such as the rectilinear or orthogonal array shown. The array has a high energy end 135 (FIG. 4), a light exit end 137, an axial center 139 and a radial perimeter 141. Septa 143 are positioned in the array such that there is a septum between adjacent ones of the imaging pixels 133.

At least one parameter, such as a physical or material parameter, of the septa varies. For example, the parameter may vary from the radially innermost strata of septa 145 that are adjacent the axial center 139 of the array 131, to the radially outermost strata of septa 151 adjacent the radial perimeter 141 of the array. The at least one parameter of the septa 143 may monotonically increase from the axial center 139 to the radial perimeter 141. The at least one parameter of the septa may comprise density or an atomic number of the septa. In some embodiments, essentially the farther a pixel 133 is from the center 139, the greater the density and/or atomic number of the material of the septum 143. This design reduces the secondary energy and electrons 153 (FIG. 4), such as x-rays, from traveling into neighboring pixels and blurring the image being produced by the imaging array. Thus, varying the parameter of the septa reduces stray energy transmission between septa and improves an image at the light exit end.

The septa 143 may comprise a plurality of materials. For example, the septa may comprise at least four strata of materials, such as a stratum 145 of polytetrafluoroethylene (PTFE; e.g., Teflon®), a stratum 147 of aluminum, a stratum 149 of copper, and a stratum 151 of tungsten. As illustrated in FIG. 3, the strata 145, 147, 149 and 151 may be configured in increasingly larger, number sign-like (“#”) patterns.

In other embodiments, the septa materials may include epoxy, silicone rubber, polyester, polyethylene, dielectric polymer films, silver, gold, tantalum, and/or lead. In addition, the septa materials may be colored white, if needed, to improve their reflectivity. For example, tungsten is a dark metal that reduces the amount of scintillation light that exits a pixel. Thus, the surfaces of tungsten septa may be painted or coated with a white material to improve the light output of the pixels. Such coloration does not affect the energy absorptive properties of the septa.

In some embodiments, powders may be used in pixel septa. Such powders may be white in color and are flowed into the spaces between the pixels to form the septa. Examples of powdered materials for septa may include Al₂O₃, MgO, MgF₂, TiO₂, ZrO₂, Ta₂O₅, PbO, and basic lead carbonate, 2PbCO₃.Pb(OH)₂. Also, powders can have advantages over monolithic solid materials in two ways. The first is that the density of powders is adjustable because the volume filling factor is somewhat adjustable. For example, if a powder is made of uniformly-sized spheres, then the powder will typically fill about 40% of the volume of the septa. The addition of some smaller particles to such spheres can increase the filling factor to over 70% of the volume of the septa. Changing the shape of the particles also affects the filling factor. Secondly, the effective atomic number (Z) may be adjusted by mixing different powders together in different proportions. For example, a portion of Ta₂O₅ (high Z) may be added to a powder that is mostly Al₂O₃, to increase its effective atomic number. In some embodiments, powders are mixed into epoxies, paints, or resins to ease assembly.

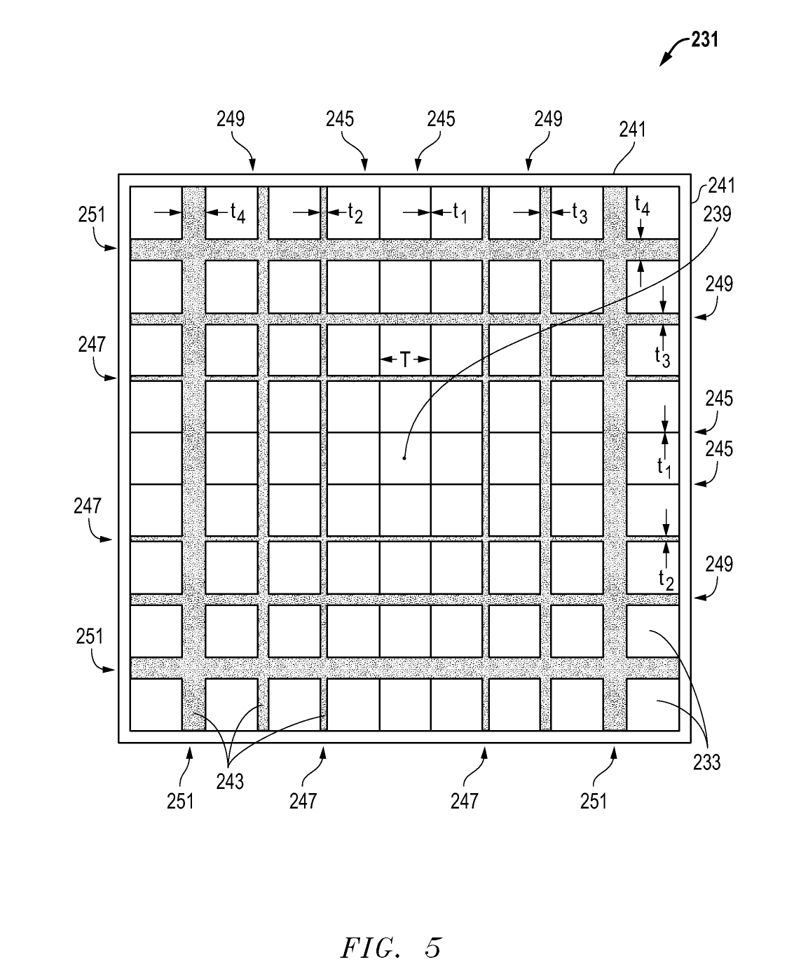

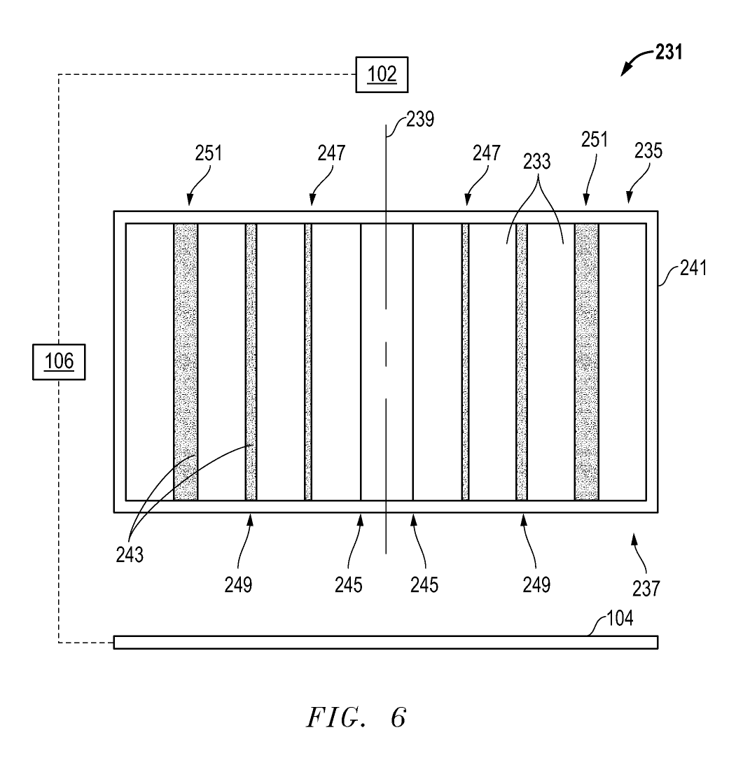

FIGS. 5 and 6 depict another embodiment of an imaging array 231, such as a scintillator pixel array. Imaging array 231 comprises a plurality of imaging pixels 233 that form an array, such as the rectilinear or orthogonal array shown. The array has a high energy end 235 (FIG. 6), a light exit end 237, an axial center 239 and a radial perimeter 241. Septa 243 are positioned in the array such that there is a septum between adjacent ones of the imaging pixels 233.

At least one parameter, such as a physical or material parameter, of the septa may be varied at least once in the septa array. For example, the parameter may vary from the radially innermost strata 245 of septa that are adjacent the axial center 239 of the array 231, to the radially outermost strata 251 of septa adjacent the radial perimeter 241 of the array. The at least one parameter of the septa 243 may monotonically increase from the axial center 239 to the radial perimeter 241. The at least one parameter may comprise, for example, a radial thickness “t” relative to the axial center 239, such that the radial thicknesses tₓ of the individual septum 243 vary. In some embodiments, the septa 243 may have an average radial thickness that is approximately one-tenth of a radial thickness T (FIG. 5) of one of the imaging pixels 233.

In the embodiment shown, the strata 245 of the septa has a radial thickness t₁, the strata 247 of the septa has a radial thickness t₂, the strata 249 of the septa has a radial thickness t₃, and the strata 245 of the septa has a radial thickness t₄, where t₁<t₂<t₃<t₄. As illustrated in FIG. 5, the strata 245, 247, 249 and 251 of the septa may be configured in increasingly larger, number sign-like (“#”) patterns.

In still other embodiments, some of the strata of septa may be equal (or non-decreasing) in radial thickness with, while others vary in size (e.g., t1=t2=t3<t4=t5, etc.) The term “monotonic” implies these options, where the septa may remain the same over a selected range of radial distance.

The invention has numerous advantages. Compton scattering can be attenuated by using septa with, for example, increased atomic number and/or density. Such configurations reduce the secondary x-rays and electrons from traveling into neighboring pixels. The result is less detector blur and greater quality images. Such designs may be used in high energy x-ray imaging devices such as those used in cancer therapy machines, cargo scanners, industrial x-ray applications and computed tomography (CT). Other applications include general radiation detection, finding a direction to a radiation source by tilting or rotating the array, and reducing parallax in positron emission tomography (PET) scanners.

In some embodiments, such devices may comprise a machine for scanning, diagnosing or characterizing features of a target, for example. The machine may have an source of radiant energy 102 (FIGS. 4 and 6) for emitting energy; an imaging array comprising a plurality of imaging pixels that form an array, the array having a high energy end for receiving the emitted energy, a light exit end, an axial center and a radial perimeter; septa positioned in the array such that there is a septum between adjacent ones of the imaging pixels; and at least one parameter of the septa is varied at least once from the septa adjacent the axial center of the array to the septa adjacent the radial perimeter of the array; an output device 104 for displaying an image from the light exit end; and a user interface 106 coupled to the source of radiant energy 102 and output device 104. In some embodiments, computations may be performed after images are acquired, such as flat-fielding or tomographic reconstructions, as is known to those of ordinary skill in the art.

The solutions disclosed herein are superior to uniform high-density septa since the septa absorb and scatter x-rays that reduce detector efficiency. Using high density material only where it is needed does not degrade the image in the center of the array.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the orders in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. An imaging array, comprising:
a plurality of imaging pixels that form an array, the array having a high energy end, a light exit end, an axial center and a radial perimeter;
septa positioned in the array such that there is a septum between adjacent ones of the imaging pixels; and
at least one parameter of the septa is varied at least once from the septa adjacent the axial center of the array to the septa adjacent the radial perimeter of the array.

2. An imaging array according to claim 1, wherein the at least one parameter of the septa increases from the axial center to the radial perimeter.

3. An imaging array according to claim 1, wherein the at least one parameter of the septa is density of the septa.

4. An imaging array according to claim 1, wherein the at least one parameter of the septa is an atomic number of the septa.

5. An imaging array according to claim 1, wherein the septa comprise a plurality of materials.

6. An imaging array according to claim 1, wherein the septa comprise at least four strata formed from at least two different materials.

7. An imaging array according to claim 1, wherein each of the septa has a radial thickness relative to the axial center, and the at least one parameter of the septa is the radial thicknesses of the septa.

8. An imaging array according to claim 1, wherein the septa have an average radial thickness that is approximately one-tenth of a radial thickness of one of the imaging pixels.

9. An imaging array according to claim 1, wherein the septa comprise at least two different materials selected from the group consisting of polytetrafluoroethylene (PTFE), aluminum, copper, tungsten, epoxy, silicone rubber, polyester, polyethylene, dielectric polymer films, silver, gold, tantalum, and lead.

10. An imaging array according to claim 1, wherein at least some of the septa are colored white to improve reflectivity.

11. An imaging array according to claim 1, wherein at least some of the septa are formed by powder.

12. An imaging array according to claim 11, wherein the powder is located in a space between adjacent pixels and has a volume fill factor therein, and a density of the powder is adjustable based on the volume fill factor.

13. An imaging array according to claim 12, wherein the powder comprises uniformly-sized particles.

14. An imaging array according to claim 12, wherein the powder comprises uniformly-sized particles and relatively smaller particles to increase the volume fill factor.

15. An imaging array according to claim 11, wherein the powder has an effective atomic number that is adjustable by mixing different powders together in different proportions.

16. An imaging array according to claim 11, wherein the powder is mixed into an epoxy, paint or resin.

17. An imaging array according to claim 1, wherein varying said at least one parameter of the septa reduces stray energy transmission between septa and improves an image at the light exit end.

18. A scintillator pixel array, comprising:
a plurality of scintillation pixels that form an array, the array having a high energy end, a light exit end, an axial center and a radial perimeter;
septa positioned in the array in strata, such that there is a septum between adjacent ones of the scintillation pixels; and
at least one physical parameter of the septa varies with each strata of septa from the strata of septa adjacent the axial center of the array to the strata of septa adjacent the radial perimeter of the array.

19. A scintillator pixel array according to claim 18, wherein the at least one physical parameter of the septa monotonically increases from the axial center to the radial perimeter.

20. A scintillator pixel array according to claim 18, wherein the at least one physical parameter of the septa is density or an atomic number of the septa.

21. A scintillator pixel array according to claim 18, wherein the septa comprise a plurality of materials that are configured in an orthogonal pattern.

22. A scintillator pixel array according to claim 18, wherein the septa comprise at least four strata, each formed from a different type of material.

23. A scintillator pixel array according to claim 18, wherein each of the septa has a radial thickness relative to the axial center, and the at least one physical parameter of the septa is the radial thicknesses of the septa.

24. A scintillator pixel array according to claim 23, wherein the septa have an average radial thickness that is approximately one-tenth of a radial thickness of one of the scintillation pixels.

25. A scintillator pixel array according to claim 18, wherein the septa comprise different materials selected from the group consisting of polytetrafluoroethylene (PTFE), aluminum, copper, tungsten, epoxy, silicone rubber, polyester, polyethylene, dielectric polymer films, silver, gold, tantalum, and lead.

26. A scintillator pixel array according to claim 18, wherein at least some of the septa are colored white to improve reflectivity.

27. A scintillator pixel array according to claim 18, wherein at least some of the septa are formed by powder.

28. An imaging array according to claim 27, wherein the powder is located in a space between adjacent pixels and has a volume fill factor therein, and a density of the powder is adjustable based on the volume fill factor.

29. A scintillator pixel array according to claim 27, wherein the powder comprises uniformly-sized particles.

30. An imaging array according to claim 28, wherein the powder comprises uniformly-sized particles and relatively smaller particles to increase the volume fill factor.

31. A scintillator pixel array according to claim 27, wherein the powder has an effective atomic number that is adjustable by mixing different powders together in different proportions.

32. A scintillator pixel array according to claim 27, wherein the powder is mixed into an epoxy, paint or resin.

33. An imaging array according to claim 18, wherein varying said at least one parameter of the septa reduces stray energy transmission between septa and improves an image at the light exit end.

34. A machine, comprising:
a source of radiant energy for emitting energy;
an imaging array, comprising:
a plurality of imaging pixels that form an array, the array having a high energy end for receiving the emitted energy, a light exit end, an axial center and a radial perimeter;
septa positioned in the array such that there is a septum between adjacent ones of the imaging pixels; and
at least one parameter of the septa is varied at least once from the septa adjacent the axial center of the array to the septa adjacent the radial perimeter of the array;
an output device for displaying an image from the light exit end; and
a user interface coupled to the source of radiant energy and output device.

35. A machine according to claim 34, wherein the at least one parameter of the septa increases from the axial center to the radial perimeter.

36. A machine according to claim 34, wherein the at least one parameter of the septa is density of the septa.

37. A machine according to claim 34, wherein the at least one parameter of the septa is an atomic number of the septa.

38. A machine according to claim 34, wherein the septa comprise a plurality of materials.

39. A machine according to claim 34, wherein the septa comprise at least four strata formed from at least two different materials.

40. A machine according to claim 34, wherein each of the septa has a radial thickness relative to the axial center, and the at least one parameter of the septa is the radial thicknesses of the septa.

41. A machine according to claim 34, wherein the septa have an average radial thickness that is approximately one-tenth of a radial thickness of one of the imaging pixels.

42. A machine according to claim 34, wherein the septa comprise at least two different materials selected from the group consisting of polytetrafluoroethylene (PTFE), aluminum, copper, tungsten, epoxy, silicone rubber, polyester, polyethylene, dielectric polymer films, silver, gold, tantalum, and lead.

43. A machine according to claim 34, wherein at least some of the septa are colored white to improve reflectivity.

44. A machine according to claim 34, wherein at least some of the septa are formed by powder.

45. A machine according to claim 44, wherein the powder is located in a space between adjacent pixels and has a volume fill factor therein, and a density of the powder is adjustable based on the volume fill factor.

46. A machine according to claim 44, wherein the powder comprises uniformly-sized particles.

47. A machine according to claim 45, wherein the powder comprises uniformly-sized particles and relatively smaller particles to increase the volume fill factor.

48. A machine according to claim 44, wherein the powder has an effective atomic number that is adjustable by mixing different powders together in different proportions.

49. A machine according to claim 44, wherein the powder is mixed into an epoxy, paint or resin.

50. A machine according to claim 34, wherein varying said at least one parameter of the septa reduces stray energy transmission between septa and improves an image at the light exit end.
